(19) United States
(12) Patent Application Publication
(10) Pub. No.: US 2026/0053689 A1
(43) Pub. Date: Feb. 26, 2026

(54) ARM SUPPORTING MECHANISM AND UPPER LIMB REHABILITATION ROBOT

(71) Applicant: Futronics (NA) Corporation, Pasadena, CA (US)

(72) Inventors: QIANSHAN LI, Pasadena, CA (US); Wenda Xu, Pasadena, CA (US); Fangyun Zhao, Pasadena, CA (US); Chengkun Zhang, Pasadena, CA (US)

(21) Appl. No.: 18/813,108

(22) Filed: Aug. 23, 2024

(51) Int. Cl. A61H 1/02

(52) U.S. Cl. CPC A61H 1/0274; A61H 2201/1215; A61H 2201/14; A61H 2201/1454; A61H 2201/1638; A61H 2201/1659; A61H 2201/5058

(57) ABSTRACT

An arm supporting mechanism for an upper limb rehabilitation robot includes: a main body; an actuator fixed to the main body; a driving gear that is connected to the actuator and is to rotate in response to actuation of the actuator; a torque sensor connected to the actuator and the driving gear; a driven ring gear meshed with the driving gear and slidably connected to main body; and an armrest that is fixed to the ring gear and is to provide support to an arm of a user.

### TECHNICAL FIELD

The present disclosure generally relates to rehabilitation robots, and in particular relates to an arm supporting mechanism and an upper limb rehabilitation robot.

### BACKGROUND

After a stroke or other illnesses, patients may experience limited limb mobility. To aid in gradual recovery, rehabilitation robots can assist patients with limb movements. For instance, these robots can provide traction to mobilize the patient's limbs and resistance that patients must overcome to strengthen muscles through exercise.

Upper limb rehabilitation robots primarily assist patients in rehabilitating their upper limbs. Typically, the patient's arm is placed on an armrest, and the robot provides traction through the armrest to mobilize the upper limb. However, human arm movements are intricate, and current armrest motion modes are limited, lacking force feedback capabilities to meet patients' needs for rehabilitation.

Therefore, there is a need to provide an arm support mechanism and upper limb rehabilitation robot to overcome the above-mentioned problem.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic isometric view of an upper limb rehabilitation robot according to one embodiment.

FIG. 2 is a schematic isometric view of an arm supporting mechanism according to one embodiment.

FIG. 3 is another schematic isometric view of the arm supporting mechanism viewed from a different perspective.

FIG. 4 is a cross-sectional view of the arm supporting mechanism.

FIG. 5 is a cross-sectional view of the arm supporting mechanism, with certain components being omitted for clarity.

FIG. 6 is a schematic isometric view of a sensor adapter according to one embodiment.

FIG. 7 is another schematic isometric view of the sensor adapter viewed from a different perspective.

FIG. 8 is a schematic isometric view of an actuator according to one embodiment.

FIG. 9 is an enlarged view of a portion A in FIG. 2.

FIG. 10 is a partial cross-sectional view of the arm supporting mechanism showing the detail of a first screw and a second screw for connecting a bearing assembly to a main body of the arm supporting mechanism.

FIG. 11 is a schematic isometric view of the bearing assembly according to one embodiment.

FIG. 12 is a schematic isometric view of a main body of the arm supporting mechanism according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

After a stroke or other illnesses, patients may experience limited limb mobility. To aid in gradual recovery, rehabilitation robots can assist patients with limb movements. For instance, these robots can provide traction to mobilize the patient's limbs and resistance that patients must overcome to strengthen muscles through exercise.

Upper limb rehabilitation robots primarily assist patients in rehabilitating their upper limbs. Typically, the patient's arm is placed on an armrest, and the robot provides traction through the armrest to mobilize the upper limb. However, human arm movements are intricate, and current armrest motion modes are limited, lacking force feedback capabilities to meet patients' needs for rehabilitation.

In order to alleviate the above-mentioned technical problems, the present disclosure proposes and upper limb rehabilitation robot 1000 and an arm supporting mechanism 100. The upper limb rehabilitation robot 1000 may include a robotic arm and the arm supporting mechanism 100 is connected to the robotic arm. The arm supporting mechanism 100 may include an actuator, a torque sensor, a driving gear, a driven ring gear, and an armrest. In response to the actuation of the actuator, the driving gear drives the driven ring gear to rotate, thereby rotating the armrest connected to the driven ring gear. The arm where the armrest is attached will undergo angular changes along with the armrest, meeting the requirement for arm motion. This sensor can accurately read or provide feedback on the output torque, facilitating precise control of the torque output. This enables adjustment of the output torque according to the specific conditions of patients, meeting personalized rehabilitation needs. The upper limb rehabilitation robot 1000 and an arm supporting mechanism 100 will be described in detail below.

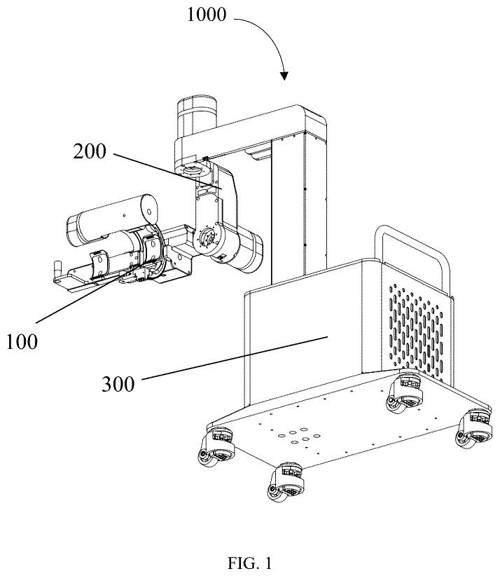

Referring to FIG. 1, in one embodiment, the upper limb rehabilitation robot 1000 may include a base 300, a robotic arm 200 and the arm supporting mechanism 100. One end of the robotic arm 200 is fixed to the base 300, and the other end of the robotic arm 200 is connected with the arm supporting mechanism 100. The robotic arm 200 is to drive the arm supporting mechanism 100 to move. The robotic arm 200 may be a multi-axis robot arm, which can move the arm supporting mechanism 100 to a desired position to facilitate the placement of the arm of a user.

The arm supporting mechanism 100 serves as the end-effector of an upper limb rehabilitation robot, with the arm of a user placed on an armrest of the arm supporting mechanism 100 during use. During operation of the arm support mechanism 100, the arm of the user can rotate along with the armrest. Additionally, the arm support mechanism 100 can provide a certain amount of rotational resistance, requiring the arm to overcome this resistance during movement. In one embodiment, the arm supporting mechanism 100 may include an actuator, a torque sensor, a driving gear, a driven ring gear, and an armrest. In response to the actuation of the actuator, the driving gear drives the driven ring gear to rotate, thereby rotating the armrest connected to the driven ring gear. The angle of the arm placed on the armrest can be automatically adjusted, enabling rotational traction of the arm to assist the arm in the rehabilitation exercise. The torque sensor can measure the output torque of the actuator, allowing for adjustment of the corresponding output torque based on the condition of the patient to meet personalized rehabilitation needs. By driving the armrest to rotate through the driving gear and the driven ring gear, the transmission chain can be shortened, the mechanical clearance can be reduced, and the overall torsional strength can be increased.

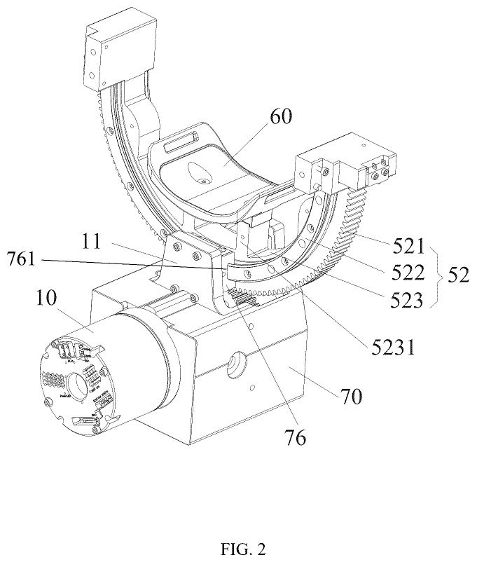

Referring to FIGS. 2-4, in one embodiment, the arm supporting mechanism 100 may include an actuator 10, a torque sensor 30, a driving gear 51, a driven ring gear 52, an armrest 60 and a main body 70. The actuator 10, the torque sensor 30 and the driving gear 51 are connected to each other in sequence.

The actuator 10 is a power output device for the arm support mechanism 100. The actuator 10 includes a power output member 11, which can output rotational motion. The power output member 11 of the actuator 10 is connected with the torque sensor 30, so that the rotational motion of the actuator 10 can be transmitted to the torque sensor 30.

The torque sensor 30 is to measure the output torque of the actuator 10. The user can directly read the output torque to facilitate accurate control of the actuator 10. The torque sensor 30 is connected to the actuator 10 and the driving gear 51 so that the mechanical power from the actuator 10 can be transmitted to the driving gear 51.

The driving gear 51 is fixedly connected to the torque sensor 30, and the driving gear 51 has multiple teeth, and the driving gear 51 can be coaxially arranged with the actuator 10. The driven ring gear 52 has multiple teeth, and the driven ring gear 52 and the driving gear 51 are meshed with each other, so that the mechanical power from the actuator 10 can be transmitted to the driven ring gear 52. By meshing the driving gear 51 with the driven ring gear 52, the transmission chain of the arm supporting mechanism 100 can be shortened and the mechanical transmission gap can be reduced. Compared with a gear, the driven ring gear 52 occupies less space, and the area enclosed by it can be arranged with other structures, making the arm supporting mechanism 100 more compact.

The armrest 60 is to support the arm of a user. The arm can be placed or fixed on the armrest 60. The armrest 60 provides support to the arm. The armrest 60 is fixed inside the driven ring gear 52. The driven ring gear 52 has a certain curvature. The area enclosed by it can be regarded as the inside of the driven ring gear 52. The armrest 60 can make full use of the internal space of the driven ring gear 52, reduce the volume of the arm supporting mechanism 100, and make the arm mechanism 100 more compact.

The main body 70 is to install the actuator 10 therein, and the actuator 10 is fixed to the main body 70. For example, the external housing of the actuator 10 is fixedly connected to the main body 70. The main body 70 can be a single-piece structure or an assembly including multiple independent components connected to one another. The driven ring gear 52 is slidably connected to the main body 70. The main body 70 not only serves to install the actuator 10 but also provides sliding guidance for driven ring gear 52, ensuring its stable rotation without the need for a connecting shaft at the center of driven ring gear 52. In one embodiment, one end of the robotic arm 200 is connected to the main body 70.

When the placement position of the arm of a user needs to be adjusted, the actuator 10 operates. The driving gear 51 then rotates, and drives the driven ring gear 52 and the armrest 60 thereon to rotate. This can adjust the angle of the armrest 60, and the angle of the arm placed on the armrest 60 is also adjusted accordingly, thereby pulling the arm to move.

In summary, the arm supporting mechanism 100 may include the actuator 10, the torque sensor 30, the driving gear 51, the driven ring gear 52, the armrest 60 and the main body 70. In response to the actuation of the actuator 10, the driving gear 51 drives the driven ring gear 52 to rotate, thereby rotating the armrest 60 connected to the driven ring gear 52. The angle of the arm placed on the armrest 60 can be automatically adjusted, enabling rotational traction of the arm to assist the arm in the rehabilitation exercise. The torque sensor 30 can measure the output torque of the actuator 10, allowing for adjustment of the corresponding output torque based on the condition of the patient to meet personalized rehabilitation needs. By driving the armrest 60 to rotate through the driving gear 51 and the driven ring gear 52, the transmission chain can be shortened, the mechanical clearance can be reduced, and the overall torsional strength can be increased.

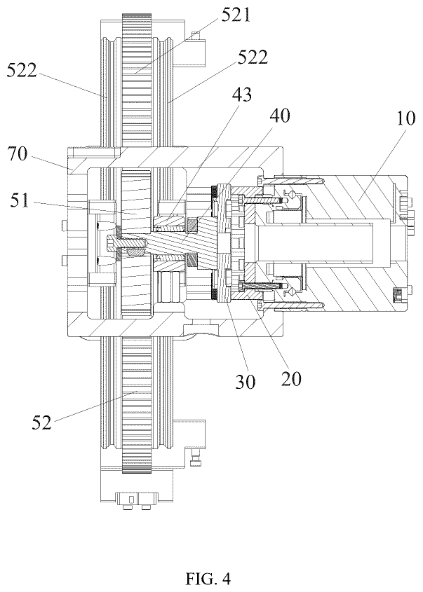

In one embodiment, the actuator 10 can be a rotating motor. Referring to FIGS. 4-7, the actuator 10 and the torque sensor 30 can be connected to each other through a sensor adapter 20. In one embodiment, the sensor adapter 20 may include a base 21 and a mounting portion 22 protruding from a first side surface of the base 21 toward the actuator 10. In one embodiment, the mounting portion 22 is a cylindrical wall extending along the edge of the base 21. The power output member 11 of the actuator 10 is fixedly connected to the base 21, and the torque sensor 30 is fixedly connected to the mounting portion 22. The torque sensor 30 is arranged between the power output member 11 of the actuator 10 and the sensor adapter 20. The actuator 10 can output a rotational motion, and the axial direction of the actuator 10 is the direction of the rotational axis for its output rotational motion.

Due to various reasons such as structural differences, size differences, and specification differences between the actuator 10 and the torque sensor 30, the actuator 10 and the torque sensor 30 may not be directly connected to each other. By providing the sensor adapter 20, an indirect connection between the actuator 10 and the torque sensor 30 can be achieved.

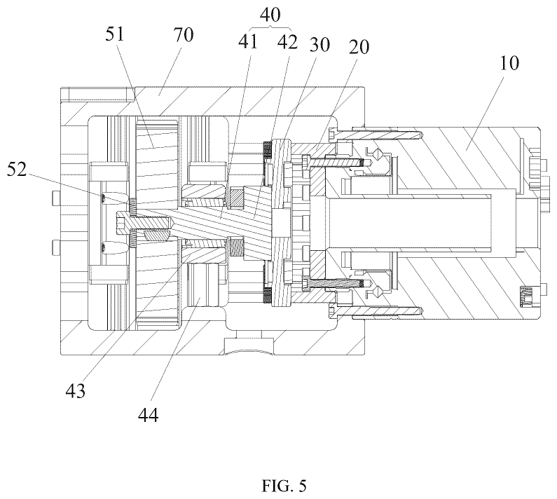

Referring to FIGS. 5-8, in one embodiment, the base 21 is provided with a number of first connection holes 211 arranged in a first circle. The mounting portion 22 is provided with a number of second connection holes 221 arranged in a second circle. The diameter of the first circle is smaller than the diameter of the second circle. The power output member 11 of the actuator 10 is provided with a number of third connection holes 12 aligned with the first connection holes 211, and the torque sensor 30 is provided with a number of fourth connection holes aligned with the second connection holes 221. The number of the first connection holes 211 is multiple and arranged in a first circle. The third connection holes 12 are arranged one-to-one with the first connection holes 211, the numbers of the connection holes 211 and 12 are the same, and the third connection holes 12 are also arranged in a circle having the same diameter as the first circle. The base 21 may be fixedly connected to the power output member 11 of the actuator 10 by fasteners (e.g., screws) passing through the first connection holes 211 and the third connection holes 12. The number of the second connection holes 221 is multiple and arranged in a second circle. The fourth connection holes are arranged one-to-one with the second connection holes 221, and the numbers of the second connection holes 221 and the fourth connection holes are the same. The fourth connection holes are also arranged in a circle having the same diameter as the second circle. The mounting portion 22 and the torque sensor 30 are fixedly connected to each other by fasteners (e.g., screws) passing through the second connection holes 221 and the fourth connection holes. Since the diameter of the first circle is smaller than the diameter of the second circle, the actuator 10 and the torque sensor 30 cannot be directly connected to each other, this is why a sensor adapter 20 is needed.

The first connection holes 211 and the second connection holes 221 are both arranged in a circle, which can more stably connect the actuator 10 and the sensor adapter 20, and the sensor adapter 20 and the torque sensor 30 together.

In one embodiment, the mounting portion 22 extends from the edge of the base 21 along the radial direction of the actuator 10 and toward the torque sensor 30, so as to facilitate the mutual connection between the mounting portion 22 and the torque sensor 30.

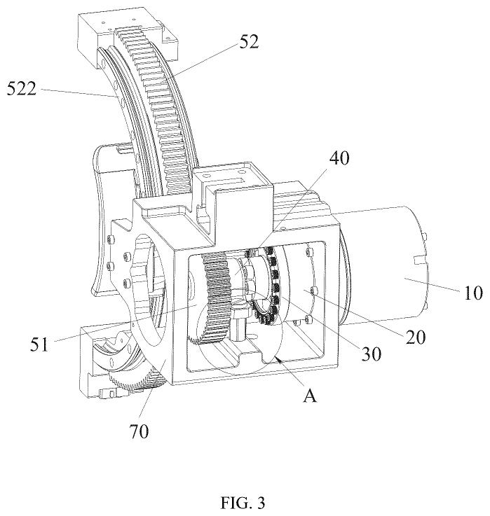

Referring to FIGS. 3-6, in one embodiment, the inner lateral surface of the mounting portion 22 is provided with a number of recesses 222 for avoiding fasteners such as screws connecting the sensor adapter 20 and the power output member 11 of the actuator 10 together. The recesses 222 may be arc-shaped to match the shape of the heads of the fasteners.

Referring to FIGS. 5-8, in one embodiment, the sensor adapter further includes a positioning ring 23 protruding from a second side surface of the base 21 away from the mounting portion 22. The positioning ring 23 is to radially position the output member 11 of the actuator 10. The positioning ring 23 extends from the base 21 toward the actuator 10, and is to radially position the power output member 11 of the actuator 10. Here, radial positioning means that the power output member 11 of the actuator 10 and the positioning ring 23 are fixed to each other in the radial direction of the actuator 10, and they cannot move relative to each other in the radial direction of the actuator 10.

By forming a positioning ring 23 along the edge of the base 21, the positioning ring 23 forms a radial match with the power output member 11 of the actuator 10, and the sensor adapter 20 can be radially positioned when the sensor adapter 20 is mounted on the actuator 10. Then, the sensor adapter 20 and the actuator 10 are axially and circumferentially fixed to each other by fasteners passes through the first connection holes 211 and the third connection holes 12.

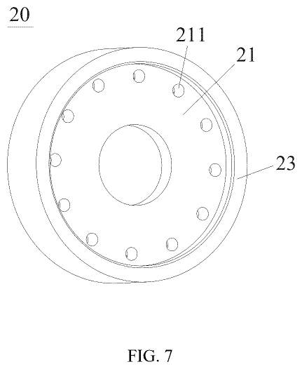

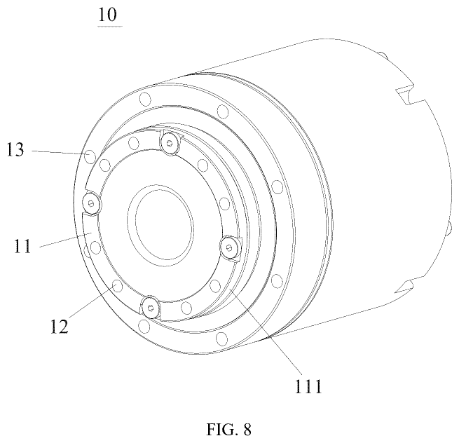

Referring to FIGS. 7 and 8, in one embodiment, the power output member 11 of the actuator 10 includes a protruding portion 111 on its end. The protruding portion 111 is received in the receiving hole surrounded by the positioning ring 23, and the receiving hole and the protruding portion 111 have the same shape and size, thereby forming radial positioning for the output member 11 of the actuator 10.

In one embodiment, the positioning ring 23 is circular. The inner lateral surface and the outer lateral surface are both cylindrical for matching with the actuator 10 and the sensor adapter 20 and other structures.

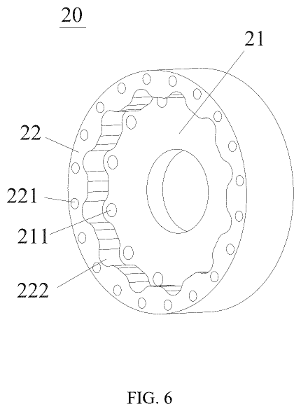

Referring to FIGS. 6 and 7, in one embodiment, the base 21 is circular, and the mounting portion 22 and the position ring 23 are both circular rings. The outer diameters of the mounting portion 22 and the positioning ring 23 are the same. The mounting portion 22 and the positioning ring 23 both extend along the edge of the base 21 and are disposed on opposite axial ends of the base 21. The mounting portion 22 is to connect with the torque sensor 30, and the positioning ring 23 is to position and engage with the power output member 11 of the actuator 10. The outer diameters of the mounting portion 22 and the positioning ring 23 are the same, so that there is no step or concave-convex structure formed between the mounting portion 21 and the positioning ring 23, and the mounting portion 22 and the positioning ring 23 can be regarded as an integral structure.

By setting the outer diameters of the mounting portion 22 and the positioning ring 23 to be the same, the outer peripheral surface of the sensor adapter 20 is smooth, the structure of the sensor adapter 20 is simplified, and the processing difficulty and processing cost are reduced.

In another embodiment, the base 21 may be in a disc shape or an annular shape, and whether a center hole is provided on the base 21 depends on specific circumstances.

Referring to FIGS. 4 and 5, in one embodiment, the torque sensor 30 and the driving gear 51 are fixedly connected to each other through an output shaft 40. A bearing assembly 43 is arranged around the lateral surface of the output shaft 40. The bearing assembly 43 may include a bearing holder 431 and a bearing 432 received in the bearing holder 431. The bearing 432 has an inner ring tightly arranged around the output shaft 40. The bearing holder 431 is fixed to the main body 70 through. For example, the bearing assembly 43 may further include two connection portions 4311 protruding from the bearing holder 431. Each connection portions 4311 may be fixed to the main body 70 through a connection member 44. Since the bearing assembly 43 is arranged around the lateral surface of the output shaft 40, and the connection member 44 is supported between the main body 70 and the connecting portion 4311 of the bearing assembly 43, which can support the output shaft 40 and reduce the radial runout of the output shaft 40.

The torque sensor 30 and the driving gear 51 can be conveniently connected to each other through the output shaft 40. It also allows for adjustment of the relative position between the driving gear 51 and the torque sensor 30, making it easier to arrange other structures. The lateral surface of the output shaft 40 is provided with the bearing assembly 43, and combined with the connection members 44, a support is formed for the output shaft 40 to reduce the radial runout of the output shaft 40.

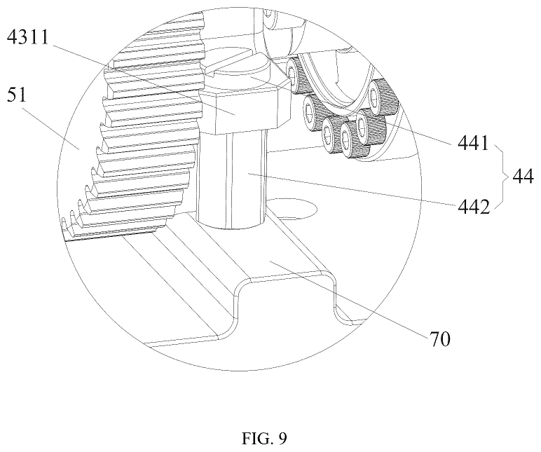

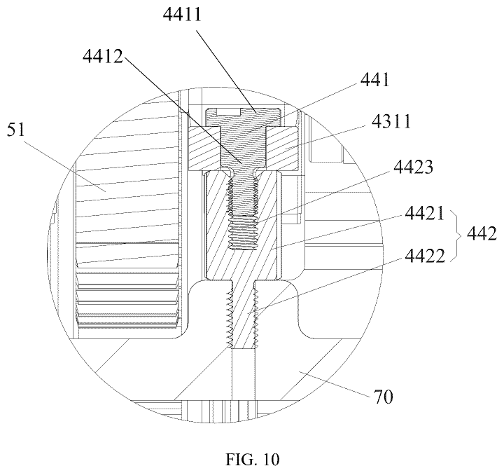

Referring to FIGS. 9-11, in one embodiment, each connection portion 4311 of the bearing holder 431 defines a through hole 4312, and the main body defines a first threaded hole 73 aligned with each through hole 4312. Each connection member 44 may include a first screw 442 and a second screw 441. The first screw 442 may include a first head 4421 and a first shank 4422, and the second screw 441 may include a second head 4411 and a second shank 4412. The first shank 4422 is screwed into the first threaded hole 73 in the main body 70. The first head 4421 defines a second threaded hole 4423. The second shank 4412 passes through the through hole 4312 and is screwed into the second threaded hole 4423. When fixing the bearing assembly 43 to the main body 70, the first shank 4422 of the first screw 442 is first screwed into the main body 70. Then the second shank 4412 is passed through the through hole 4312 of each connection portion 4311 and screwed into the threaded hole 4423 of the first screw 442. The opposite ends of the first head 4421 are respectively abutted against the connection portion 4311 and the main body 70.

Each connection member includes a first screw 442 and a second screw 441, the second screw 441 connects the connection portion 4311 and the first screw 442 together, and the first screw 442 connects the second screw 441 to the main body 70. This forms a fixed connection between the bearing assembly 43 and the main body 70. Opposite ends of the first head 4421 are in contact with the connection portion 4311 and the main body 70, providing effective support for the bearing assembly 43.

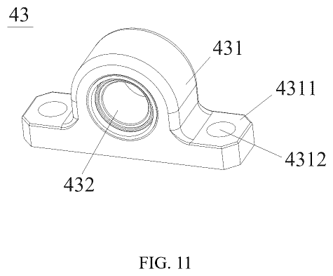

In another embodiment, referring to FIG. 11, the bearing holder 431 of the bearing assembly 43 and the connecting portions 4311 are integrally formed, and no additional connecting means is required to connect the bearing holder 431 and the connecting portions 4311 together.

In the embodiment shown in FIG. 11, there are two connection portions 4311, which are respectively arranged on opposite sides of the bearing holder 431. The two connection portions 4311 are both provided with a through hole 4312, so that the connection between the bearing holder 431 and the main body 70 can be more stable, and the support for the bearing assembly 43 is also more stable.

Referring to FIG. 5, in one embodiment, the output shaft 40 includes a shaft body 41 and a head 42 which are connected to each other. The diameter of the head 42 is larger than the diameter of the shaft body 41. The head 42 is fixedly connected to the torque sensor 30, and the shaft body 41 is fixedly connected to the driving gear 51.

In one embodiment, the torque sensor 30 is fixedly connected to the head 42 of the output shaft 40 by means of a fastener such as a screw. The fastener passes through the head 42 and the torque sensor 30 to achieve a fixed connection between them.

In one embodiment, the center of the driving gear 51 is provided with a center hole for the output shaft 40 to extend into. A fastener such as a screw is threadedly connected to one end of the output shaft 40, and the head of the screw abuts against the end face of the driving gear 51, so that the driving gear 51 and the output shaft 40 are fixed to each other. A washer can be provided between the head of the screw and the driving gear 51, which can protect the driving gear 51 and make the connection between the driving gear 51 and the output shaft 40 more stable.

Referring to FIGS. 2, 3 and 12, in one embodiment, the main body 70 may include a hollow frame 71 defining a chamber 711 and a guide member 76 connected to the frame 71. The guide member is to guide the driven ring gear 52. The frame 71 defines a mounting hole 74 in communication with the chamber 711. The actuator 10 passes through the mounting hole 74 and is received in the chamber 711, and the torque sensor 30 and the driving gear 51 are both arranged in the chamber 711. The frame 71 is designed in a framework structure and may include multiple interconnected panels. The panels can be formed by a sheet-like structure or by interlaced beams, which can reduce the weight of the frame while also providing accommodation functionality. The mounting hole 74 is defined in one side surface of the frame 71. A small portion of the actuator 10 extends into the chamber 711 and the rest of the actuator 10 is exposed, and the actuator 10 is mounted at the mounting hole 74.

The main body 70 has a chamber, which can accommodate a small portion of the actuator 10, the torque sensor 30 and the driving gear 51, and can also accommodate the sensor adapter, and protect the above-mentioned components. Additionally, the main body 70 is provided with the mounting hole 74, so that the actuator 10 can be mounted and fixed on the main body 70.

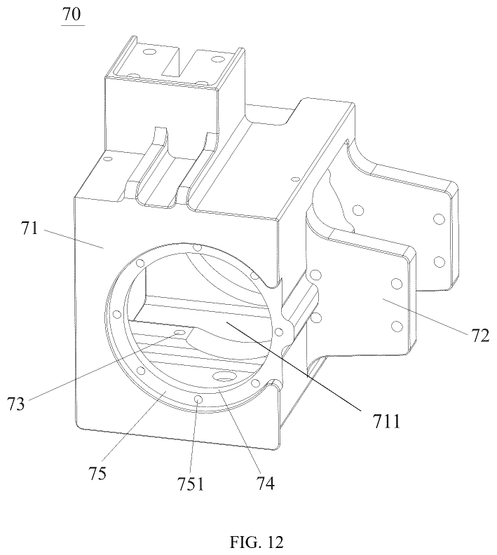

Referring to FIGS. 2 and 12, in one embodiment, two walls 72 protruding from one side of the frame 71 and are spaced apart from each other. The guide member 76 is fixed to one of the two walls 72. This allows for a certain distance between the driven ring gear 52 and the frame 71, so as to facilitate the arrangement and installation of the driving gear 51 and the driven ring gear 52.

Referring to FIG. 12, in one embodiment, a recess 75 is defined in the surface of the frame 71 where the mounting hole 74 is located. One end of the actuator 10 is received in the recess 75. The design of the recess 75 allows for the mounting and positioning of the actuator 10. The actuator 10 is provided with a number of threaded holes 13, and the bottom surface of the recess 75 is provided with a number of holes 751. Fasteners such as screws pass through the through holes 751 and are screwed into the threaded hole 13, thereby fixing the actuator 10 to the main body 70.

Referring to FIGS. 2-4, in one embodiment, the driven ring gear 52 may include a gear body 521 and two guide rails 522 fixed to opposite axial ends of the gear body 521. In this case, two guide members 76 are employed and each guide member 76 defines a guide groove 761. The direction of the rotation axis of the gear body 521 is the circumferential direction of the gear body 521. The two axial end faces of the gear body 521 are two end faces arranged opposite to each other in its axial direction. Both end faces extend in an arc shape, matching the overall shape of the gear body 521. Correspondingly, the two guide rails 522 are also arranged in an arc shape. The two guide rails 522 are matched with the two guide members 76 in a one-to-one correspondence. The guide rails 522 are slidably connected with the guide members 76, so that the driven ring gear 52 can rotate stably with respect to the main body 70.

Two guide rails 522 are provided on opposite sides of the gear body 521. The two guide rails 522 cooperate with the two guide members 76 in a one-to-one guiding manner, so that the sliding of the driven ring gear 52 relative to the guide members 76 is more stable.

In one embodiment, the cross-sections of the guide rail 522 and the guide groove 761 are both dovetail-shaped, so that the guide rail 522 can only rotate and limit its movement in other directions. When installing the guide members 76, the two guide members 76 can be first slid from the end of the driven ring gear 52 to a desired position, and then the guide members 76 and the walls 72 of the frame 71 are fixedly connected to each other.

Referring to FIGS. 2 and 3, in one embodiment, a mounting frame 523 is fixed to the inner lateral surface of the gear body 521, and the armrest 60 is fixed on the mounting frame 523. The mounting frame 523 is arc-shape, and has two protruding blocks 5231 extending toward the center of the gear body 521. The armrest 60 is fixed on the protruding blocks 5231, so that a certain distance is maintained between the armrest 60 and the gear body 521, so as to prevent the arm of a user and the driven ring gear 52 from colliding with each other.

Referring to FIGS. 2 and 3, in one embodiment, the driven ring gear 52 is arc-shaped. This allows the driven ring gear 52 to mesh with the driving gear 51. Since the driven ring gear 52 is not closed, which occupies a relatively small space while meeting the requirements for the adjustment of angle of the arm of a user. The armrest 60 is positioned inside the driven ring gear 52, making full use of the spare space within the driven ring gear 52, which makes the structure of the arm supporting mechanism 100 more compact.

In one embodiment, the arc of the driven ring gear 52 ranges from 120 degrees to 150 degrees, with its specific arc not being limited here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An arm supporting mechanism for an upper limb rehabilitation robot, the arm supporting mechanism comprising:
a main body;
an actuator fixed to the main body;
a driving gear connected to the actuator and configured to rotate in response to actuation of the actuator;
a torque sensor connected to the actuator and the driving gear;
a driven ring gear meshed with the driving gear and slidably connected to main body; and
an armrest fixed to the ring gear and configured to provide support to an arm of a user.

2. The arm supporting mechanism of claim 1, further comprising a sensor adapter, wherein the actuator and the torque sensor are connected to each other through the sensor adapter, the sensor adapter comprises a base and a mounting portion protruding from the base, the actuator comprises an output member that is fixed to the base, and the torque sensor is fixed to the mounting portion.

3. The arm supporting mechanism of claim 2, wherein the base defines a plurality of first connection holes, the mounting portion defines a plurality of second connection holes, the output member of the actuator defines a plurality of third connection holes aligned with the first connection holes, and the torque sensor defines a plurality of fourth connection holes aligned with the second connection holes.

4. The arm supporting mechanism of claim 3, wherein the sensor adapter further comprises a positioning ring protruding from the base away from the mounting portion, and the positioning ring is configured to radially position the output member of the actuator.

5. The arm supporting mechanism of claim 4, wherein the base is circular, and the mounting portion and the positioning ring are both circular rings.

6. The arm supporting mechanism of claim 1, further comprising an output shaft, a bearing assembly and a connection member, wherein the bearing assembly comprises a bearing holder and a bearing received in the bearing holder, the torque sensor and the driving gear are fixed to each other through the output shaft, the bearing comprising an inner ring tightly arranged around the output shaft, and the bearing holder is fixed to the main body through the connection member.

7. The arm supporting mechanism of claim 6, wherein the bearing holder defines a through hole, the main body defines a first threaded hole aligned with the through hole, the connection member comprises a first screw and a second screw, the first screw comprises a first head and a first shank, the second screw comprises a second head and a second shank, the first shank is screwed into the first threaded hole in the main body, the first head defines a second threaded hole, and the second shank passes through the through hole and is screwed into the second threaded hole.

8. The arm supporting mechanism of claim 1, wherein the main body comprises a hollow frame defining a chamber and a guide member connected to the frame, the guide member is configured to guide the driven ring gear, the frame defines a mounting hole in communication with the chamber, the actuator passes through the mounting hole and is received in the chamber, and the torque sensor and the driving gear are both arranged in the chamber.

9. The arm supporting mechanism of claim 8, wherein the driven ring gear comprises a gear body and a guide rail fixed to the gear body, the guide member defines a guide groove, the guide rail is engaged with the guide groove, thereby allowing the guide rail to be guided by the guide member so as to slide with respect to the guide member.

10. An arm supporting mechanism for an upper limb rehabilitation robot, the arm supporting mechanism comprising:
a main body;
an actuator fixed to the main body and comprising a rotating output member that is configured to provide a rotational motion;
a driving gear coaxially connected to the output member, the driving gear rotatable together with the output member;
a torque sensor connected to the actuator and the driving gear;
an arc-shaped driven ring gear meshed with the driving gear and movable connected to main body; and
an armrest fixed to the ring gear and configured to provide support to an arm of a user.

11. The arm supporting mechanism of claim 10, wherein the main body comprises a hollow frame defining a chamber and a guide member connected to the frame, the guide member is configured to guide the driven ring gear, the frame defines a mounting hole in communication with the chamber, the actuator passes through the mounting hole and is received in the chamber, and the driving gear is arranged in the chamber.

12. The arm supporting mechanism of claim 11, wherein the driven ring gear comprises a gear body and a guide rail fixed to the gear body, the guide member defines a guide groove, the guide rail is engaged with the guide groove, thereby allowing the guide rail to be guided by the guide member so as to slide with respect to the guide member.

13. An upper limb rehabilitation robot comprising:
a base;
a robotic arm connected to the base; and
an arm supporting mechanism connected to the robotic arm, the arm supporting mechanism comprising:
a main body;
an actuator fixed to the main body;
a driving gear connected to the actuator and configured to rotate in response to actuation of the actuator;
a torque sensor connected to the actuator and the driving gear;
a driven ring gear meshed with the driving gear and slidably connected to main body; and
an armrest fixed to the ring gear and configured to provide support to an arm of a user.

14. The upper limb rehabilitation robot of claim 13, further comprising a sensor adapter, wherein the actuator and the torque sensor are connected to each other through the sensor adapter, the sensor adapter comprises a base and a mounting portion protruding from the base, the actuator comprises an output member that is fixed to the base, and the torque sensor is fixed to the mounting portion.

15. The upper limb rehabilitation robot of claim 14, wherein the base defines a plurality of first connection holes, the mounting portion defines a plurality of second connection holes, the output member of the actuator defines a plurality of third connection holes aligned with the first connection holes, and the torque sensor defines a plurality of fourth connection holes aligned with the second connection holes.

16. The upper limb rehabilitation robot of claim 15, wherein the sensor adapter further comprises a positioning ring protruding from the base away from the mounting portion, and the positioning ring is configured to radially position the output member of the actuator.

17. The upper limb rehabilitation robot of claim 16, wherein the base is circular, and the mounting portion and the positioning ring are both circular rings.

18. The upper limb rehabilitation robot of claim 13, further comprising an output shaft, a bearing assembly and a connection member, wherein the bearing assembly comprises a bearing holder and a bearing received in the bearing holder, the torque sensor and the driving gear are fixed to each other through the output shaft, the bearing comprising an inner ring tightly arranged around the output shaft, and the bearing holder is fixed to the main body through the connection member.

19. The upper limb rehabilitation robot of claim 18, wherein the bearing holder defines a through hole, the main body defines a first threaded hole aligned with the through hole, the connection member comprises a first screw and a second screw, the first screw comprises a first head and a first shank, the second screw comprises a second head and a second shank, the first shank is screwed into the first threaded hole in the main body, the first head defines a second threaded hole, and the second shank passes through the through hole and is screwed into the second threaded hole.

20. The upper limb rehabilitation robot of claim 13, wherein the main body comprises a hollow frame defining a chamber and a guide member connected to the frame, the guide member is configured to guide the driven ring gear, the frame defines a mounting hole in communication with the chamber, the actuator passes through the mounting hole and is received in the chamber, and the torque sensor and the driving gear are both arranged in the chamber.
